(19) United States
(12) Patent Application Publication
(10) Pub. No.: US 2011/0125700 A1
(43) Pub. Date: May 26, 2011

(54) USER MODEL PROCESSING DEVICE

(76) Inventor: Junichi Funada, Tokyo (JP)

(21) Appl. No.: 13/054,705

(22) PCT Filed: Jun. 5, 2009
(86) PCT No.: PCT/JP2009/002548

§ 371 Date: Jan. 18, 2011

(30) Foreign Application Priority Data
Jul. 24, 2008 (JP) 2008-190655

(51) Int. Cl. G06N 5/02

(52) U.S. Cl. 706/50

(57) ABSTRACT

A model to predict a transition of a user's usage for a terminal device is generated from an operation record. A usage cluster generating unit (111) generates multiple user groups (131) consisting of users whose characteristic values representing a usage characteristic calculated from operation record information are similar according to the operation record information of the multiple first users of the terminal device. A usage transition model generating unit (112) analyzes that the characteristic value representing the usage characteristic calculated from the operation record information is similar to which of the usage characteristics of the plurality of the user groups (131) for each operation record information of each divided section, each divided section being obtained by dividing the operation record information of a plurality of second users of the terminal device, and generates a transition model (141) representing a transition relationship between the user groups (131) according to the analysis result.

### TECHNICAL FIELD

The invention relates to a device for generating a transition model of a user's usage of a terminal device, a device for predicting a future usage of an arbitrary user using a generated transition model, and a device for recommending information according to a predicted usage to the user.

### BACKGROUND ART

A terminal device such as a cellular phone, a personal computer, or a home electronic appliance has been highly functionalized year after year, and has a lot of functions including a function which a beginner can easily use and a function which only a person with some skill can use. Some products include an instruction manual that explains the functions according to a user's learning level by labeling the functions as a basic version and a practiced version, for example. However, the user's learning level needs to be judged by the user oneself, which makes it difficult to judge the learning level objectively and accurately. Therefore, when the user tries to use a function which the user does not master, situations easily arise in which an acknowledgment load applied to the user increases and errors occur, resulting in deterioration of a user's convenience.

On the other hand, Patent Literature 1 discloses a technique in which the user's learning level is judged based on a user's operation record for a terminal device and a display method of devices is controlled so as to improve the user's convenience. In the technique described in Patent Literature 1, the present user's learning level is judged based on usage record information from the time of purchase of the terminal device (for example, a cellular phone) to the present time and a display is simplified according to the user's learning level.

### CITATION LIST

Patent Literature

PTL 1: Japanese Unexamined Patent Application Publication No. 2006-202320

### SUMMARY OF INVENTION

### Technical Problem

According to the technique described in Patent Literature 1 in which the user's learning level is judged based on the user's operation record for the terminal device, the user's learning level can be judged automatically based on an objective fact as the operation record. Therefore, when the technique is applied to a technique for recommending to the user a function according to the present learning level, a service for recommending the functions according to the present learning level to the user among a variety of functions installed in the terminal device can be realized. However, a service for recommending the functions according to not the present learning level but the near future learning level cannot be realized.

It is somewhat effective to recommend functions according to the present user's learning level. However, to promote a further improvement in the user's learning level, the recommendation of the functions according to not the present learning level but the near future learning level is preferred. Therefore, a technique capable of objectively judging not the present learning level but the near future learning level is needed.

Generally, in multifunctional devices such as a cellular phone device and a personal computer, for example, as shown in FIG. 13, even if all users firstly belong to the same beginner user group, differences arise in skilled directions depending on individual favorites and habits, usage objects, and the like. The users are branched into multiple different user groups whose usage characteristics are different in such a way that one user becomes a member of a user group in which the users are skilled in operations relating to an e-mail and another user becomes a member of a user group in which the users are skilled in operations relating to word processing. For predicting a user group to which the user will belong to in the near future, it is necessary to clarify what type of user groups are to be formed and the way of transition between the user groups.

The invention has been made in view of the above circumstances, and an object of the invention is to provide a device and method for generating a model for predicting a transition of a user's usage of a terminal device according to an operation record.

### Solution to Problem

A first user model processing device of the invention includes: a usage cluster generating means for generating a plurality of user groups consisting of users based on operation record information about a plurality of first users of a terminal device, the users having similar characteristic values representing usage characteristics calculated from the operation record information; and a usage transition model generating means for analyzing that the characteristic value representing the usage characteristic calculated from the operation record information is classified in which of the plurality of user groups for each operation record information of each divided section, and for generating a transition model representing a transition relationship between the user groups based on a result of the analysis, the divided section being obtained by dividing the operation record information about a plurality of second users of the terminal device by a time.

### Advantageous Effects of Invention

According to the invention, a model for predicting a transition of a user's usage of a terminal device can be generated based on an operation record.

### BRIEF DESCRIPTION OF DRAWINGS

FIG. 1 is a block diagram of a first embodiment of the invention;

FIG. 2 is a diagram showing an example of operation record information in the invention;

FIG. 3 is a flowchart showing a processing example of the first embodiment of the invention;

FIG. 4 is a diagram for explaining an operation principle of the first embodiment of the invention;

FIG. 5 is a block diagram of a second embodiment of the invention;

FIG. 6 is a flowchart showing a processing example of the second embodiment of the invention;

FIG. 7 is a block diagram of a third embodiment of the invention;

FIG. 8 is a flowchart showing a processing example of the third embodiment of the invention;

FIG. 9 is a block diagram of an embodiment of a recommend information determining unit in the third embodiment of the invention;

FIG. 10 is a block diagram of a forth embodiment of the invention;

FIG. 11 is a block diagram of a fifth embodiment of the invention;

FIG. 12 is a block diagram of a sixth embodiment of the invention; and

FIG. 13 is a diagram showing a transition example of a user's usage of a terminal device.

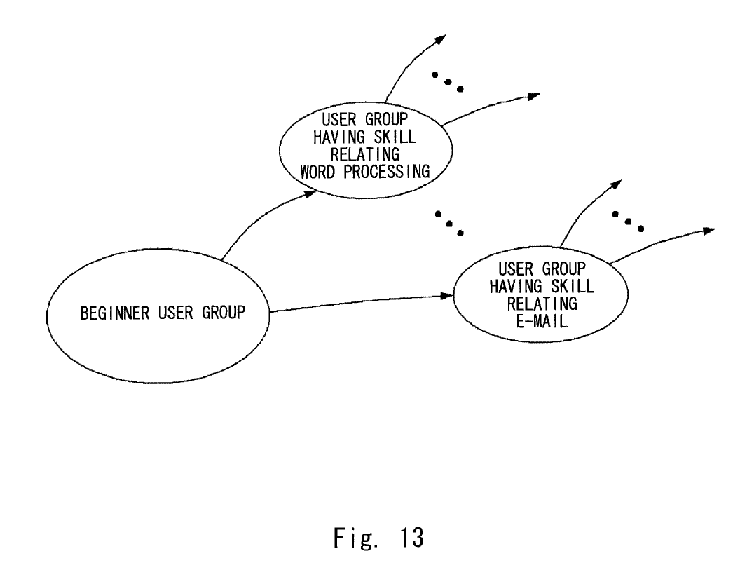

### DESCRIPTION OF EMBODIMENTS

Referring next to the drawings, embodiments of the invention will be described in detail.

### First Embodiment

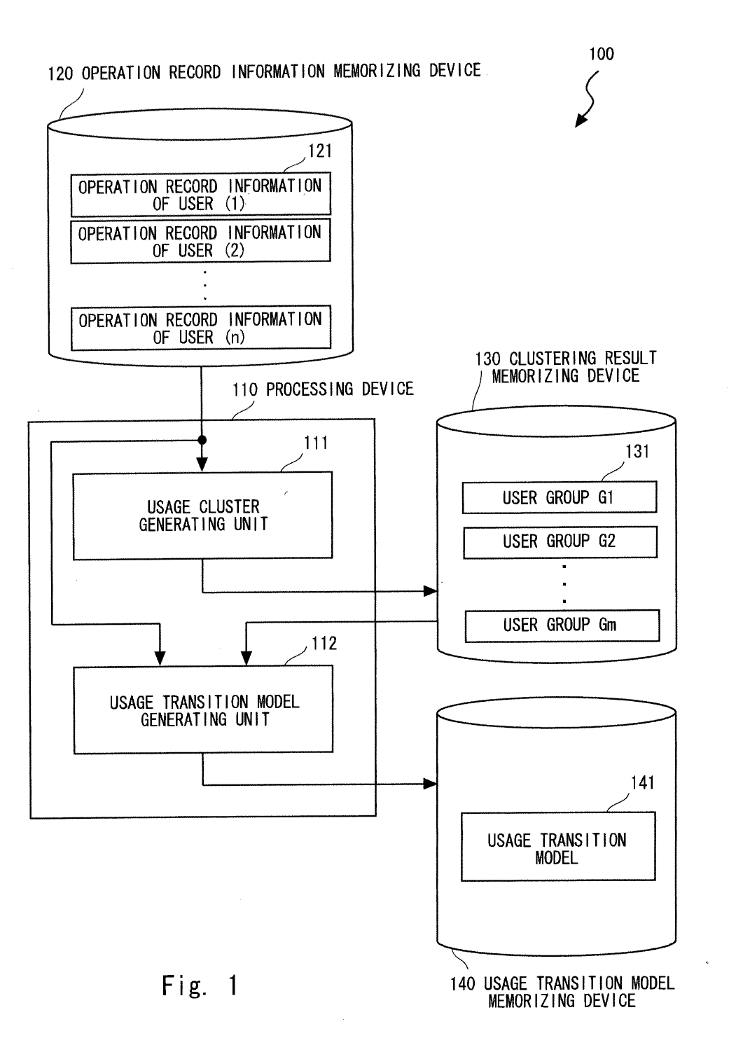

Referring to FIG. 1, a user model processing device 100 according to a first embodiment of the invention is composed of a processing device 110, an operation record information memorizing device 120 connected to the processing device 110, a clustering result memorizing device 130, and a transition model memorizing device 140.

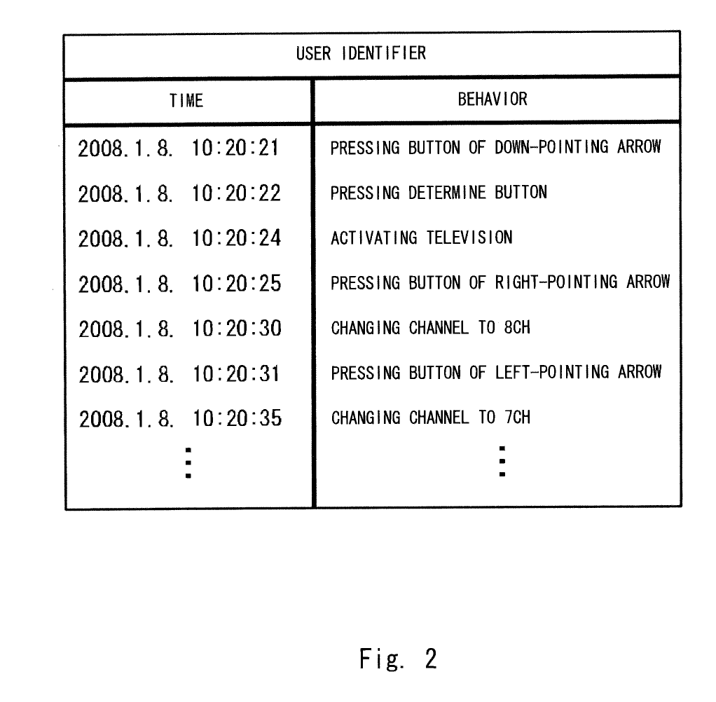

The operation record information memorizing device 120 is a database storing operation record information of multiple users in a terminal device (for example, a kind of a cellular phone device) which is an object of usage analysis. A user identifier is added to the operation record information of one user to distinguish it from operation record information of another user. For example, as shown in FIG. 2, the operation record information is memorized as a combination of a time and a user's operation at the time. As the types of the operation to be memorized as a record, ones useful for estimating the individual user's usage (such as operation learning level and type of application to be used) are preferred. For example, a detailed level at which buttons equipped in the terminal device are pressed one by one is possible, and a level such as a type of an activated application is possible. The term “applications” herein described refers to a function unit supplied by the terminal device. For example, in the cellular phone device, the applications include various type of WEB service such as an e-mail function, a telephone function, a scheduler function, a television reception function, a settlement function of electric money or the like, a function utilizing GPS, and transfer information. The applications may be more detailed function units (such as decorating e-mail, attaching a photo to e-mail, or the like). In the personal computer, the applications include word processor software, table calculation software, presentation software, e-mail software, and the other programs. Also these applications may be more detailed function units (for example, a column composing function, a table of contents generation function, a spell correcting function or the like in the word processor software). In the other type of terminal devices, a variety of functions called up by the own terminal device are targeted.

The processing device 110 is a device for generating a model to predict a transition of the user's usage of the terminal device according to the operation record information memorized in the operation record information memorizing device 120 and includes a usage cluster generating unit 111 and a usage transition model generating unit 112.

The usage cluster generating unit 111 is a means for generating the multiple user groups consisting of the users whose usages are similar, based on the operation record information of the multiple users memorized in the operation record information device 120. Specifically, characteristic values representing the user's usage are calculated based on the operation record information of the multiple users, and a clustering is performed in a linear space having the calculated characteristic values as a basal value. The space is called a usage space. Examples of the characteristic value representing the user's usage includes the number of activated applications, a list of activated applications, a time to reach an application, the number of operating buttons, a menu holding time, and an input amount to an application. The type and the number of characteristics values to be used are arbitrarily determined. Assuming that a “p” number of characteristic values x1, x2, . . . , xp are used, a vector having components of user's usage characteristic values x1, x2, . . . xp can be given. The vector is called a characteristic value vector. To perform the clustering in the linear space having the characteristic values x1, x2, . . . xp of the multiple users as a basal value means that a clustering is performed on the characteristic vectors in the usage space. As a clustering method in the usage space, clustering methods used in pattern analysis such as k-means and split-and merge method can be used.

The usage transition model generating unit 112 is a means for analyzing that the characteristic value vector of the operation record in each of multiple divided sections of the operation record information about the multiple users stored in the operation record information memorizing device 120 is classified in which user group among the multiple user groups generated by the usage cluster generating unit 111, and for generating a transition model representing a transition relation between the user groups generated by the usage clustering generating unit 111.

As the transition model, specifically, a model representing a transition between the user groups by a conditional probability with respect to an elapsed time can be used. The elapsed time may be an elapsed time from when the user first begins to use the terminal device, or an elapsed time from when the user group transits to the previous one. As another example of the transition model, assuming that a kind of user's operation for the terminal device is treated as a behavior, a model representing the transition between the user groups by a conditional probability with respect to the behavior can also be used.

The operation record information of the multiple users used in the usage transition model generating unit 112 may be exactly the same as the operation record information of the multiple users used in the usage cluster generating unit 111, and may be entirely or partially different therefrom.

The clustering result memorizing device 130 is a means for memorizing information 131 about the multiple user groups which is a clustering result of the usage cluster generating unit 111. The transition model memorizing device 140 is a means for memorizing a usage transition model 141 generated in the usage transition model generating unit 112.

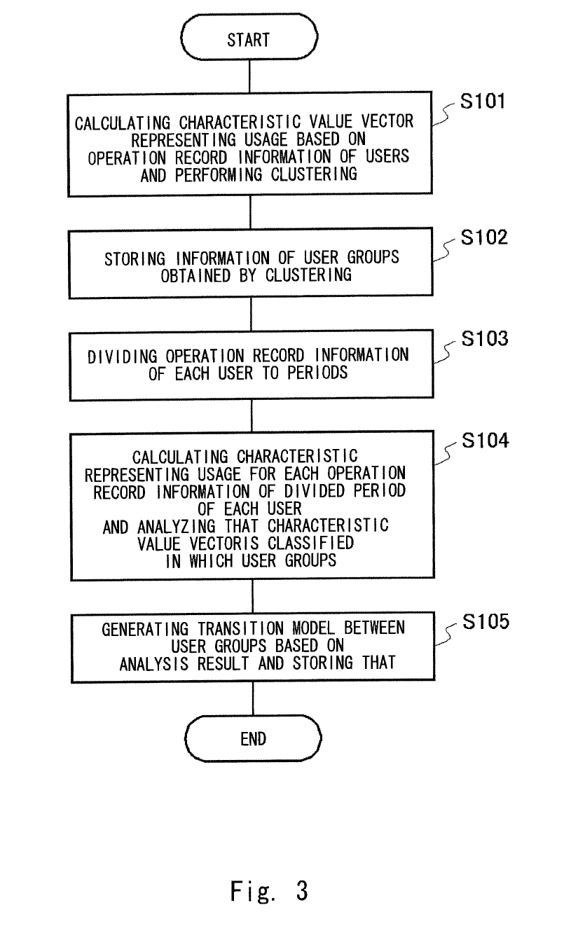

Referring to a flowchart shown in FIG. 3, operations of the embodiment will be explained.

Firstly, the usage cluster generating unit 111 reads out operation record information 121 of the multiple users from the operation record information memorizing device 120, calculates the characteristic value vector of the user's usage based on the individual operation record information 121, and clusters multiple calculated characteristic vectors (Step S101). A purpose of the clustering is to sort out, as many as possible, the user groups (clusters) whose usage characteristics are different. Therefore, it is desirable to use the operation record information about the multiple users whose learning levels and habits are different. Further, the usage characteristics change according to an elapsed usage period. Therefore, it is not preferred to use, as the operation record information, the whole operation record information about a user whose usage period is long. Meanwhile, it is preferred that the whole operation record information of the user whose usage period is long be divided into some sections, and the operation record information in each period is used like the operation record information about a different person.

Since the multiple user groups (clusters) whose usage characteristics are different are generated by the above-mentioned clustering, the usage clustering generating unit 111 stores the generated information of the multiple user groups in the clustering result memorizing device 130 (Step S102). Information of each user group includes a user group identifier for uniquely identifying a user group, information (a user identifier, a range of use of the operation record, or the like) for identifying the operation record information used for generating the user group, a characteristic value vector, and an average value thereof.

The usage transition model generating unit 112 reads out the operation record information 121 about the multiple users from the operation record information memorizing device 120 and divides each piece of the operation record information 121 into multiple sections (Step S103). Next, the characteristic value vector representing the usage is calculated for each operation record information in each divided section of each user, and it is analyzed that the characteristic value vector is classified in which user group (Step S104). Subsequently, based on the analysis result, the transition model between the user groups is generated and stored in the transition model memorizing device 140 (Step S105).

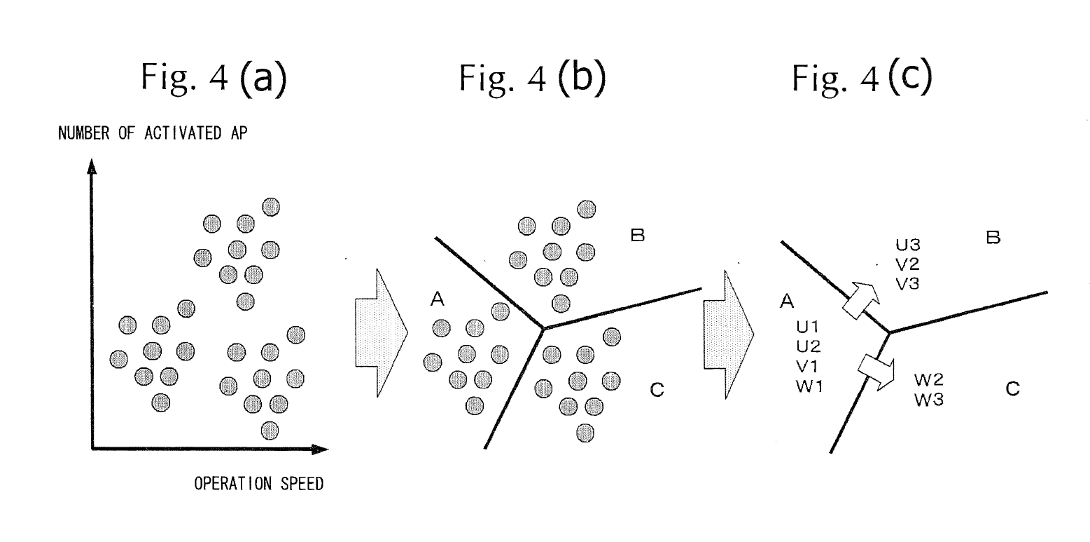

FIG. 4(a) shows an illustration in which the characteristic value vectors of the multiple users are mapped into the usage space using two characteristic values of an operation speed of button operation or the like and the number of activated applications. Two characteristic values of the operation speed and the number of the activated applications are used herein, but the type and the number of characteristic values to be used are arbitrarily determined. One circular point in the figures represents the characteristic value vector of a one user. FIG. 4(b) shows a result of clustering the multiple characteristic vectors, and three user groups (clusters) A, B and C are generated in this example. The user group A is a user group whose usage is such that the operation speed is slow and the number of the activated applications per unit time is small. The user group B is a user group whose usage is such that the operation speed is fast and the number of the activated applications per unit time is large. The user group C is a user group whose usage is such that the operation speed is fast but the number of the activated applications per unit time is small.

FIG. 4(c) shows a result of analyzing that each of characteristic value vectors U1-U3 is classified in which of the user groups A, B, and C, when the operation record information of a user X is divided into three: operation record information X1 from a start of use to a predefined time t1, operation record information X2 from the time t1 to a time t2 after a predetermined time elapsed from the time t1, and operation record information X3 from the time t2 to the present time. The characteristic value vectors U1-U3 have components of the operation speed and the number of the activated APs (applications). The operation speed and the number of the activated applications are calculated based on each operation record information X1-X3. In the example, the characteristic value vectors U1 and U2 belong to the user group A and the characteristic value vector U3 belongs to the user group B.

In the same manner, FIG. 4(c) shows a result of analyzing that each of characteristic value vectors V1-V3 is classified in which of the user groups A, B, and C, when the operation record information of another user Y is divided into three: operation record information Y1, operation record information Y2, and operation record information Y3. The characteristic value vectors V1-V3 have components of the operation speed and the number of the activated APs as the characteristic values which are calculated based on each operation record information Y1-Y3. In the case of the user Y, the characteristic value vector V1 belongs to the user group A and the characteristic value vectors V2 and V3 belong to the user group B.

In the same manner, FIG. 4(c) shows a result of analyzing that each of characteristic value vector W1-W3 are classified in which of the user groups A, B, and C, when the operation record information of still another user Z is divided into three: operation record information Z1, operation record information Z2, and operation record information Z3. The characteristic value vectors W1-W3 have components of the operation speed and the number of the activated AP as the characteristic values which are calculated based on each operation record information Z1-Z3. In the case of the user Z, the characteristic value vector W1 belongs to the user group A and the characteristic value vectors W2 and W3 belong to the user group B.

According to the analysis result shown in FIG. 4(c), the following can be stated regarding a transition manner between the user groups. Firstly, most users belong to the user group A whose usage is such that the operation speed of button operation or the like is slow and the number of the activated applications per time unit is small at the beginning of the usage of the terminal device. However, the users learn operations over time, and a part of the users X and Y transit to the user group B whose usage is such that in which the operation speed is fast and the number of the activated applications per unit time is large, and the other part of the user Z transits to the user group C whose usage is such that the operation speed is fast and the number of the activated applications is small (shown by arrows in FIG. 4(c)). It takes a long time for transit between the user groups, and it does not take a long time for the users Y and Z to do so. The usage transition model generating unit 112 generates the usage transition model characterizing the transition manner between the user groups based on these analysis results.

Next, a specific method of generating the transition model will be explained in which the transition between the user groups is represented by a conditional probability with respect to an elapsed time.

Assume that the users of the operation record information in the operation record information memorizing device 120 which is used by the usage transition model generating unit 112 are represented as evaluation object users {u(k)} (k=1, . . . , K). The usage transition model generating unit 112 calculates how the analysis object users {u(k)} transit between the multiple user groups (clusters) {Cᵢ} (i=1, N), which are generated by the usage cluster generating unit 111, as follows.

Firstly, the usage transition model generating unit 112 divides the operation record information of each user {u(k)} for each predetermined period, and judges that the characteristic value vector calculated from the operation record information of each divided unit belongs to which user group {C}. As an example of this, there is a method in which a distance between the characteristic value vector and each user group {Ci} is calculated and a user group having the smallest distance is regarded as the user group to which the characteristic value vector belongs. Examples of a method of obtaining the distance include a method in which a distance from an average or a median point in the characteristic value vectors of the components configuring each user group to the characteristic value vectors of the analysis object users is obtained.

The usage transition model generating unit 112 focuses on a combination of a user group Ci and another user group Cj, and calculates, as described below, a probability Pij(t) for individual users to transit from the user group Ci to the user group Cj after “t” days from when the individual users transit to the user group Ci by the following method. Firstly, the usage transition model generating unit 112 calculates that each evaluation object user belongs to which user group for each predetermined period. A user group to which a user u(k) belongs at the time “t” is assumed as a user group c(u(k), t). All the times “t”, in which the transition between the user groups satisfies both the following expressions, are searched, assuming that a class of “t” is represented by “T”.

c(u(k), t−1)≠Ci and c(u(k), t)=Ci (1)

Further, if the following holds, 0 is added to “T”.

c(u(k),0)=Ci (2)

Next, “s” is increased to each “t” belonging to the class “T”, and calculates “S” to satisfy both the following expressions first.

c(u(k), t+s−1)=Ci (s=1, . . . , S) (3)

and

c(u(k), t+S)=Cj (4)

Above calculations are performed on all the analysis object users, and an obtained distribution of “S” is set as the probability Pij(t) to transit from the user group Ci to the user group Cj after “t” days from when the user transits to the user group Ci.

By performing the above calculations on all combinations “i, j”, {Pij(t)} (0<i, j<N+1, i≠j) is obtained. The {Pij(t)} is a transition model representing a transition between the user groups by a conditional probability with respect to the elapsed time.

Next, a specific method of generating the transition model representing the transition between the user groups by the conditional probability with respect to a behavior will be explained.

Firstly, the usage transition model generating unit 112 focuses on a combination of one user group Ci and another user group Cj. Next, a behavior performed by the user prior to the transition from the user group Ci to the user group Cj is extracted from the operation record information 121 of the analysis object user. Assume that a class of extracted behaviors is presented by {Aijm} (m=1, . . . , M). The term “behavior” herein described refers to a function or a function sequence executed by the user, a pattern of pressing buttons, a pattern of switching ON/OFF of the power of the terminal device, opening and closing patterns of a folding or sliding type cellular phone, or the like.

The usage transition model generating unit 112 performs the following analysis for each of the components {Aijm} (m=1, M) based on the operation record information of the analysis object users.

Firstly, the number of the analysis object users Zijm who have executed a behavior Aijm while belonging to the user group Ci is calculated. Next, the number of evaluate object users Yijm who have transited from the user group Ci to the user group Cj immediately after the behavior Aijm (or after a predetermined time has elapsed since the execution of the behavior Aijm) is calculated among the analysis object users having the behavior Aijm while belonging to the user group Ci. When the behavior Aijm executed, the probability Pij(Aijm) to transit from the user group Ci to the user group Cj is calculated by the following expression immediately after the execution (or after a predetermined time has elapsed).

Pij(Aijm)=Yijm/Zijm (5)

By performing the same calculations as described above on all combinations of “i, j”, the usage transition model generating unit 112 obtains {Pij(Aijm)} (0<i, j<N+1, i j, m=1, . . . , M). {Pij(Aijm)} is a transition model representing the transition between the user groups by the conditional probability with respect to the behavior.

Advantages of this embodiment will be described.

According to this embodiment, a model for predicting a transition of a user's usage of a terminal device can be generated from the operation record information. The reasons for this are as follows. Firstly, the user groups (clusters) whose usage characteristics are different are sorted out as many as possible by clustering the users while focusing on the characteristic value vector associated with the usage calculated from the operation record information of the multiple users. Secondary, how the user belonging to each user group transits between the user groups along with an improvement in the learning level or an elapsed time is analyzed based on the operation record information of the multiple user, and the user's usage transition is modeled based on the analysis result.

According to the embodiment, the model for predicting the user's usage transition to the terminal device can be generated with high accuracy. The reason is that the model is generated based on the operation record information obtained as a result of actually using the terminal device by the multiple users in the past.

Further, according to this embodiment, the transition model representing the transition between the user groups by the conditional probability with respect to the elapsed time can be generated. In this kind of transition model, the transition between the user groups (clusters) can be predicted based on a period in which the user keeps using the terminal device. Therefore, when the correlation between the elapsed time and the user group transition is strong, the transition between user groups can be predicted with high accuracy.

According to this embodiment, the transition model representing the transition between user groups by the conditional probability with respect to the behavior can be generated. In this kind of transition model, information regarding how the user uses the terminal device can be used to predict the transition between the user groups (clusters). The transition between user groups can be predicted with high accuracy even when there is no correlation between the elapsed time and the user group transition (for example, when the usage changes after the user has learned a new function. Specifically, when the user has learned the usage of kana-kanji conversion in a cellular phone, the user frequently uses an e-mail function, for example).

### Second Embodiment

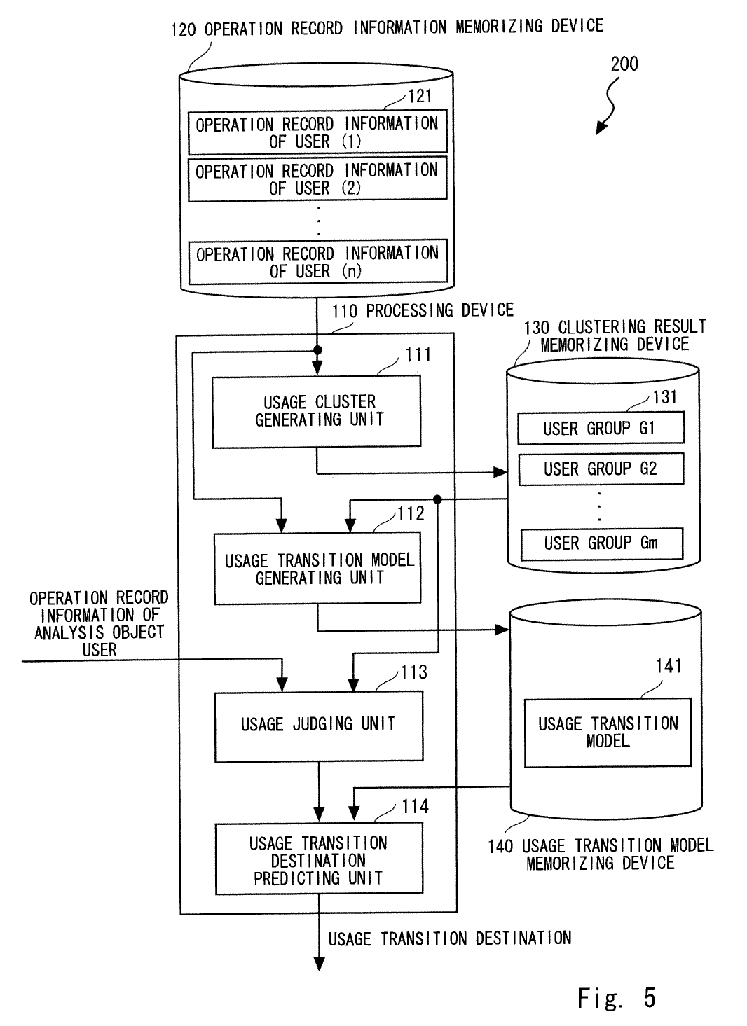

Referring to FIG. 5, a user model processing device 200 according to a second embodiment of the invention is a device in which a function of judging a user group (cluster) to which a user currently belongs from the operation record information on an arbitrary user, and further predicting the user group to which the user subsequently transits by applying a transition model is added to the user model processing device 100 according to the first embodiment shown in FIG. 1. The user model processing device 200 is a different from the user model processing device 100 in that the processing device 110 includes a usage judging unit 113 and a usage transition destination predicting unit 114 in addition to the cluster generation unit 111 and the usage transition model generation unit 112.

The usage judging unit 113 is a means for judging the characteristic value vector calculated based on the operation record information of the analysis object user is classified in which of the multiple user groups 131 memorized in the clustering result memorizing device 130.

The usage transition destination predicting unit 114 is a means for predicting the user group which the user subsequently transits to by determining that the user group judged by the usage judging unit 113 subsequently transits to which of the user groups from the usage transition model 141.

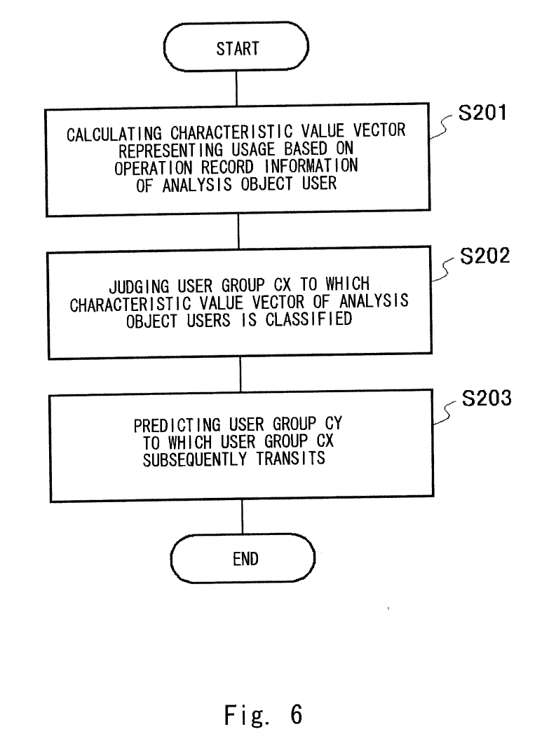

Referring next to a flowchart of FIG. 6, operations of this embodiment will be explained. Meanwhile, operations other than those of the usage judging unit 113 and the usage transition destination predicting unit 114 are the same as those of the first embodiment, and so the explanation thereof is omitted. Only operations associated with the usage judging unit 113 and the usage transition destination predicting unit 114 will be explained.

Upon receiving the operation record information of the analysis object user, the usage judging unit 113 calculates the characteristic value vector representing the user's usage from this operation record information (Step S201). The operation record information of the analysis object user has contents shown in FIG. 2, which are as those of the same as the operation record information 121 memorized in the operation record information memorizing device 120. A method of calculating the characteristic value vector is also the same as that of the usage cluster generating unit 111. Because the operation record information is used to judge the present usage of the analysis object user, it is not preferred to use whole operation record information of the analysis object user the whose usage period is long and it is preferred to use the operation record information obtained during the current time and a predetermined previous time.

The usage judging unit 113 judges that the characteristic vector value of the analysis object user belongs to which of the user groups 131 memorized in the clustering result memorizing device 130 (Step S202). For example, there is a method in which a distance between the characteristic value vector and each user group {Ci} is calculated, and the user group having a shortest distance is judged as the user group to which the characteristic value vector belongs. Examples of a method for calculating the distance include methods such as a method of calculating a distance from an average or a median point in the characteristic value vectors of the components configuring each user group to the characteristic value vectors of the analysis object users. Hereinafter, assume that a judged user group is represented by CX.

Next, the usage transition destination predicting unit 114 predicts the user group which the user group CX subsequently transits to by using the usage transition model 141 (Step S203). Assume herein that a predicted user group is represented by CY. The usage transition destination predicting unit 114 outputs the user group CY as the user group to which the analysis object user subsequently transits.

Next, an example of the usage transition destination predicting unit 114 will be explained.

[Example 1 of the Usage Transition Destination Predicting Unit 114]

The usage transition destination predicting unit 114 of this example calculates a user group j0 to which the analysis object user belonging to the user group CX subsequently transits with a highest probability, as the user group CY.

For example, when a transition model {Pij(t)} (0<i, j<N+1, i≠j) representing the transition between the usage groups by the conditional probability with respect to the elapsed time is used as the usage transition model, the user group j0 to which the analysis object user belonging to the user group CX subsequently transits with after a predetermined time T1 is obtained as the user group CY by the following expression.

j0=argij maxPij(t) (6)

The predetermined time T1 may be a constant value independent of the transition source user group, and may be a constant value predetermined according to the transition source user group. Further, it may be a variable value that can be changed from the outside.

When a transition model {Pij(Aijm)} (0<i, j<N+1, i≠j, m=1, . . . , M) representing the transition between the usage groups by the conditional probability with respect to the behavior is used as the usage transition model, a behavior Q recently executed by the analysis object user belonging to the user group CX is extracted from the operation record information. “j” for setting Pij(Q) at maximum is calculated and a user group Cj is obtained as the user group CY to which the analysis object user subsequently transits.

[Example 2 of the Usage Transition Destination Predicting Unit 114]

Using the usage transition model, the usage transition destination predicting unit 114 of this example obtains one or more user groups the analysis object user belonging to the user group CX subsequently transits with a probability equal to or higher than a predetermined threshold. The usage transition destination predicting unit 114 selects one user group from among these one or more user groups under a predetermined condition, and determines the selected user group as the user group CY to which the analysis object user subsequently transits.

As the above-mentioned predetermined condition, a condition in which the user group who masters the terminal device better is selected is preferred to further promote the improvement in the user learning level. Example of a method of judging whether it is a user group that masters the terminal device better include the following two methods:

a) A method of judgment based on the learning level; and

b) A method of judgment based on the user's satisfaction level.

The method of judgment based on the learning level utilizes a cause-effect relationship in which the user group who uses the terminal device better generally has a higher learning level. Whether the user's learning level is high or not is judged by analyzing whether the characteristic value representing the user's usage approaches a desired direction. The desired direction means, for example, that the number of activated applications is larger, and the number of variations in the list of activated applications is larger. Moreover, a shorter time required to reach an application is better, and a shorter time to stay on a menu option is better, for example. An evaluation value “J” representing whether the characteristic values approach the desired direction is calculated based on these characteristic and the user group having a large evaluation value “J” is selected. For instance, when a characteristic value which is desirable to be small is given by {an} (n=1, N) and a characteristic value which is desirable to be large is given by {bm} (m=1, . . . , M), the evaluation value “J” is given by the following expression.

J=Σ(1/an)²+Σ(bm)² (7)

The usage transition destination predicting unit 114 calculates the evaluation value “J” of each user group 131 memorized in the clustering result memorizing device 130 based on the operation record information of the user belonging to the user group 131, and holds the result. Using the usage transition model {Pij(t)} or {Pij(Aijm)}, the usage transition destination predicting unit 114 obtains one or more user groups to which the object user belonging to the user group CX subsequently transits with a probability equal to or higher than a probability exceeding the predetermined threshold, and selects a user group having the largest evaluation value “J” as the user group CY to which the analysis object user subsequently transits, from among the one or more user groups.

On the other hand, in the method of judgment based on the user's satisfaction utilizes cause-effect relationship in which many users who master the terminal device better show a higher satisfaction. The user's satisfaction is gathered through a questionnaire for the user and an index value of the user's satisfaction of each user group is calculated by processing statistics on the gathered results. Specifically, the user's satisfaction for each operation record information 121 about each user is memorized in the operation record information memorizing device 120 or another memorizing device. At this time, a time when the satisfaction is gathered by the questionnaire is specified using a relationship with the operation record.

For each user group 131 memorized in the clustering result memorizing device 130, the usage transition destination predicting unit 114 reads out the user's satisfaction associated with the operation record information used to generate the user group 131 from the operation record information memorizing device 120 or the like, calculates the index value of the user's satisfaction by calculating an average, and holds it. The user's satisfaction to be used is a user's satisfaction gathered after the end time of the operation record information of the analysis object user. Using the usage transition model {Pij(t)} or {Pij(Aijm)}, the usage transition destination predicting unit 114 obtains one or more user groups to which the analysis object user belonging to the user group CX subsequently transits with a probability equal to or higher than a probability exceeding the predetermined threshold, and selects the user group having the largest evaluation value of the user's satisfaction from among these one or more user groups as the user group CY to which the analysis object user subsequently transits.

Next, advantages of this embodiment will be explained.

According to this embodiment, the same advantages as those of the first embodiment can be obtained, and at the same time, the user group to which an arbitrary user subsequently transits can be accurately predicted. The reason is that the user group to which the user currently belongs is judged based on the operation record information of the arbitrary user, and the user group to which the user subsequently transits is predicted by applying the transition model.

### Third Embodiment

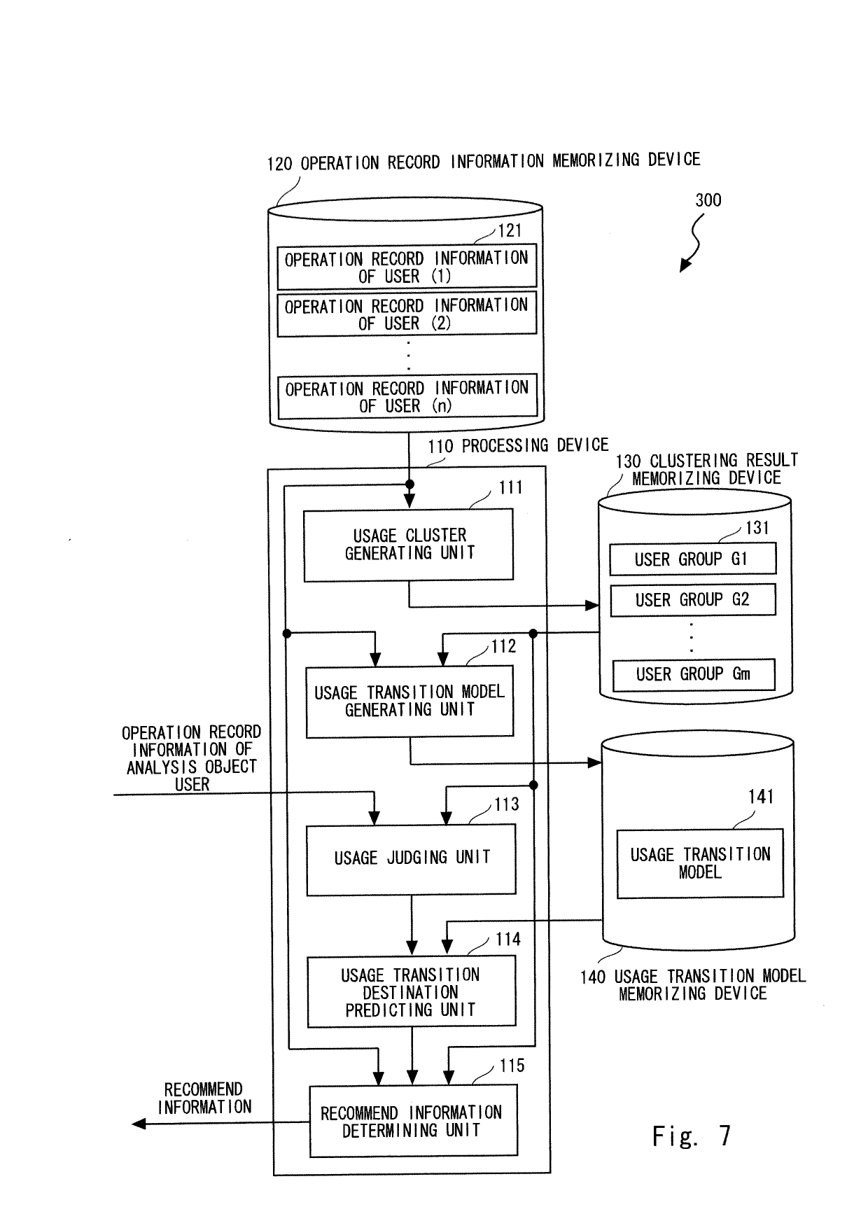

Referring to FIG. 7, a user model processing device 300 according to a third embodiment of the invention is a device in which a function of recommending a use application for an arbitrary user is added to the user model processing device 200 according to the second embodiment shown in FIG. 5. The user model processing device 300 is different from the user model processing device 200 according to the second embodiment in that the processing device 110 includes a recommend information determining unit 115 in addition to the usage cluster generating unit 111, the usage transition model generating unit 112, the usage judging unit 113, and the usage transition destination predicting unit 114.

The recommend information determining unit 115 is a means for generating information for recommending applications and outputting it. The applications are used by the user group which is predicted as the usage transition destination of a recommended object user by the usage transition destination predicting unit 114. For each user group memorized in the clustering result memorizing device 130, the recommend information determining unit 115 of this embodiment extracts names of the used applications by analyzing the operation record information used to generate the user group 131, generates recommend information including a whole or a part of extracted application names, and outputs it. Examples of a recommendation method limiting the recommend information to a part of applications include a method in which the recommend information is limited to applications used by more users belonging to the user group, a method in which the recommend information is limited to applications which is activated a number of times greater than a predetermined value, a method in which the recommend information is limited to applications which are not used by the recommended object user, and a combination thereof.

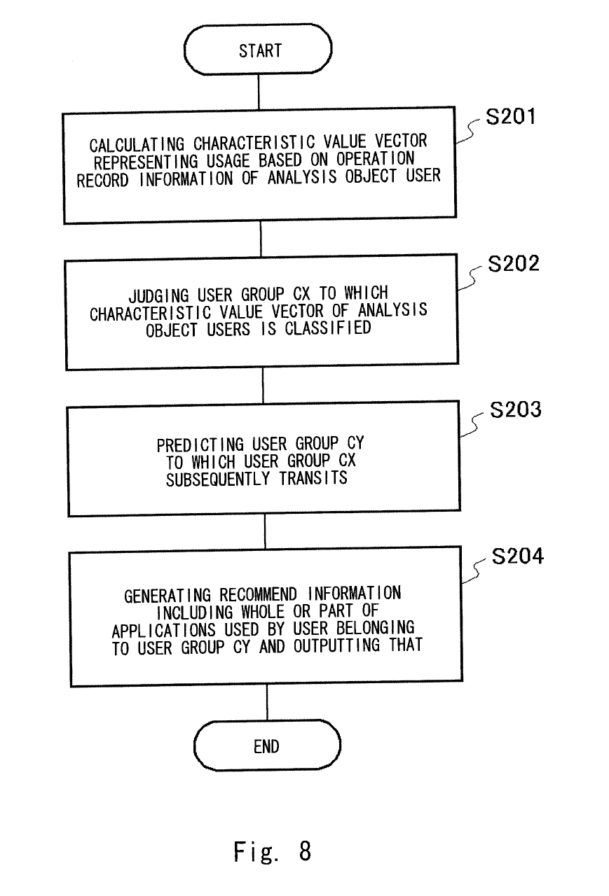

Referring to a flowchart of FIG. 8, operations of this embodiment will be explained. The operations other than those of the recommend information determining unit 115 are the same as those of the second embodiment, so the explanation thereof is omitted. Only operations associated with the recommend information determining unit 115 will be explained.

When the operation record information of the analysis object user is received by the processing device 110, the user group CX to which the analysis object user currently belongs is judged by the usage judging unit 113 as shown in steps S201 to S202, and the user group CY to which the user subsequently transits is predicted by the usage transition destination predicting unit 114 as shown in step S203. These operations are the same as those of the second embodiment. Next, a control is shifted to the recommend information determining unit 115.

The recommend information determining unit 115 generates the recommend information including the whole or a part of the names of applications used by the user belonging to the user group CY, and outputs it (Step S204).

An example of the recommend information determining unit 115 will be explained.

[Example 1 of the Recommend Information Determining Unit 115]

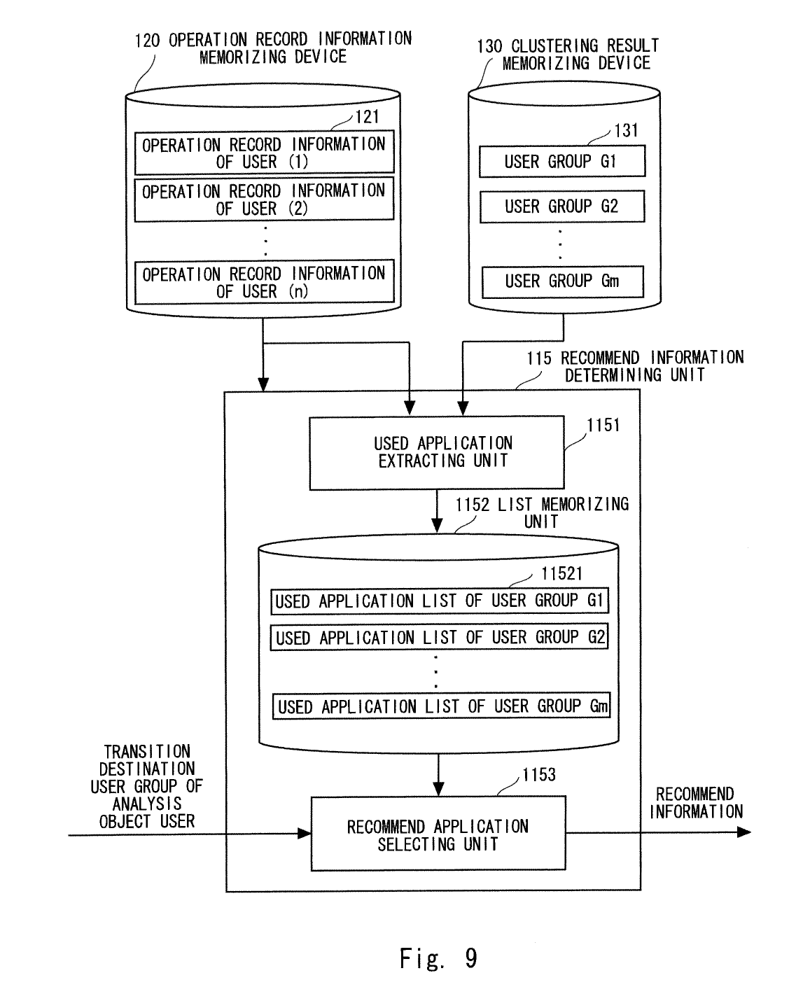

Referring to FIG. 9, the recommend information determining unit 115 of the example is composed of a use application extracting unit 1151, a list memorizing unit 1152, and a recommend application selecting unit 1153.

The used application extracting unit 1151 extracts applications used by the user group from the operation record information 121 in the operation record information memorizing device 120 for each user group 131 memorized in the clustering result memorizing device 130, creates a use application list of each user group, and memorizes it in the list memorizing unit 1152. Specifically, the operation record information used to generate the user group is read out for each user group 131 from the operation record information device 120, and all the names of the activated applications are extracted, thereby creating a list. At this time, the list may be created and memorized by performing prioritization in descending order of the number of use times or the number of users using the application.

The list memorizing unit 1152 is a database holding the use application list 11521 for each user group generated by the used application extracting unit 1151.

Upon receiving the transition destination user group CY of the analysis object user from the usage transition destination predicting unit 114, the recommend application selecting unit 1153 retrieves the use application list of the user group CY from the list memorizing unit 1152, creates the recommendation information indicating the whole or a part of the applications listed in the use application list as recommend candidate applications, and outputs it. In this time, applications may be extracted from the operation record information of the analysis object user, and the applications that have already been used by the analysis object user may be excluded from the recommended candidates among the applications in the use application list of user group CY.

The creation of the use application list for each user group by the use application extracting unit 1151 may be started after the transition destination user group of the analysis object user is input to the recommend information determining unit 115, or may be started beforehand at the time when the multiple user groups are generated in the clustering result memorizing device 130 without waiting for the input. In the latter case, the computational complexity required for recommendation can be reduced.

Next, advantages of the embodiment will be explained.

According to the embodiment, the same advantages as those of the second embodiment can be obtained, and at the same time, the applications which the user can execute without effort can be recommended to promote the improvement in the analysis object user's usage. The reason is that the applications used in the user group to which the analysis object user subsequently transits from the user group to which the user currently belongs are recommended.

### Forth Embodiment

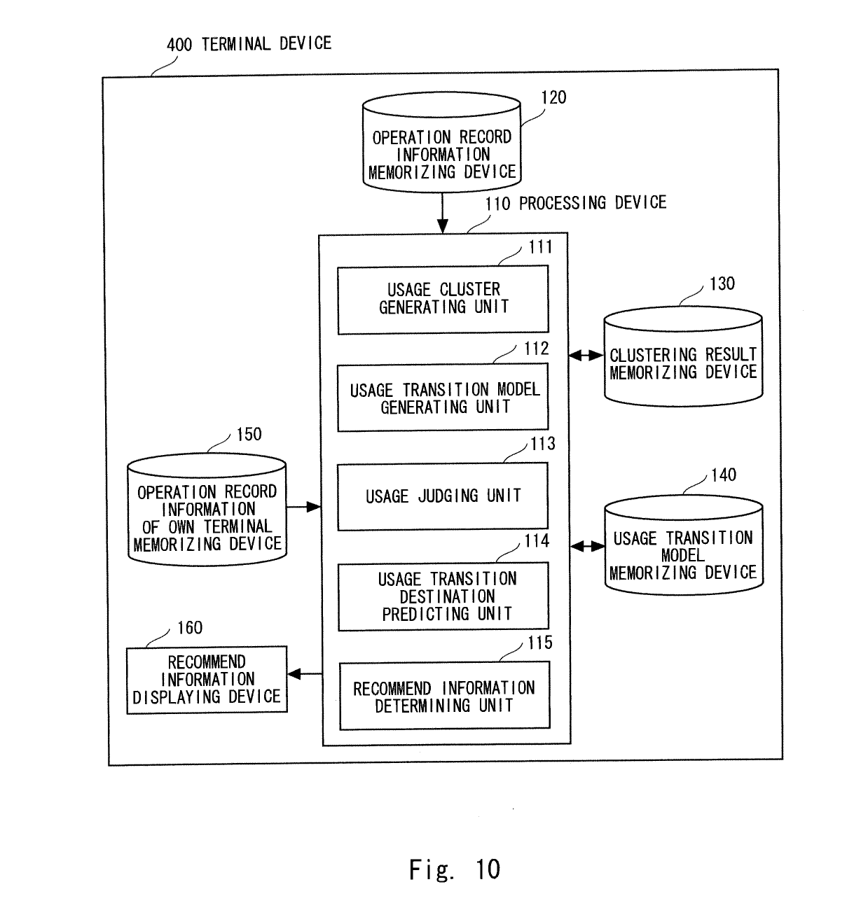

Referring to FIG. 10, according to a forth embodiment of the invention, a terminal device 400 of an analysis object user includes the processing device 110, the operation record information memorizing device 120, the clustering result memorizing device 130, and the transition model memorizing device 140, and further includes a memory device 150 for memorizing the operation record of the own terminal and a displaying device 160 for displaying the recommend information. The processing device 110 includes the usage cluster generating unit 111, the usage transition model generating unit 112, the usage judging unit 113, the usage transition destination predicting unit 114, and the recommend information determining unit 115 which are described in the third embodiment.

The usage cluster generating unit 111 and the usage transition model generating unit 112 execute the operations explained in the third embodiment at a suitable time, such as an initial start time of using the terminal device 400, generate information of the multiple user groups based on the operation record information memorized in the operation record information memorizing device 120, and memorize it in the clustering result memorizing device 130. Moreover, the usage judging unit 113 reads out the operation record information of the own terminal from the memory device 150 at a suitable time when the analysis object user uses the terminal device 400, executes the operations explained in the third embodiment, and judges the user group to which the analysis object user belongs. Subsequently, the usage transition destination predicting unit 114 predicts the user group to which the user subsequently transits by the method explained in the third embodiment, and the recommend information determining unit 115 executes the operations explained in the third embodiment and determines the applications as the recommend candidates. The recommend information determining unit 115 outputs the recommend information including the application name of the recommend candidate and the like to the recommend information displaying device 160. The recommend information displaying device 160 presents the received recommend information to the analysis object user by displaying the received recommend information on a display screen.

According to this embodiment, all the operations including the generation of the multiple user groups and the transition models, and judgment of the transition destination by using the models, and determination and display of recommend information can be executed within the terminal device.

### Fifth Embodiment

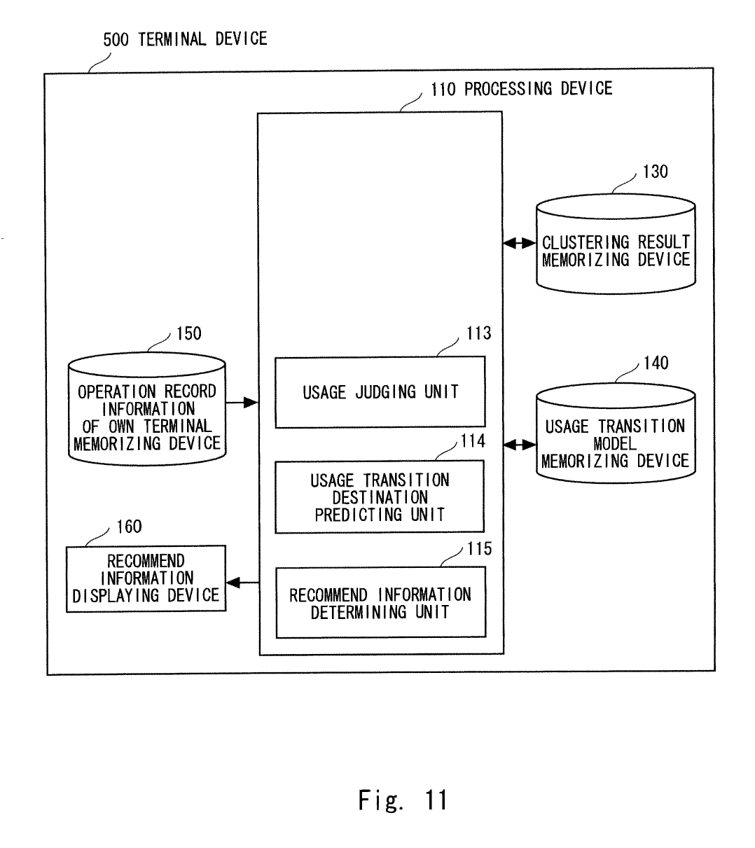

Referring to FIG. 11, in a fifth embodiment of the invention, a terminal device 500 of an analysis object user includes the clustering result memorizing device 130 and the transition model memorizing device 140, which memorize the multiple user groups and the transition models generated by the same method as that of the third embodiment, and the processor unit 110 including the usage judging unit 113, the usage transition destination predicting unit 114, and the recommend information determining unit 115, and further includes the memory device 150 for memorizing the operation record information of the own terminal and the displaying device 160 for displaying the recommend information. The recommend information determining unit 115 has built therein the list memorizing unit 1152 for storing the use application list for each user group as explained above by referring to FIG. 9.

The usage judging unit 113 reads out the operation record information from the memory device 150 at a suitable time when the analysis object user uses the terminal device 500, executes the operations explained in the third embodiment, and judges the user group to which the analysis object user belongs. Subsequently, the usage transition destination predicting unit 114 predicts the user group to which the user subsequently transits by the method explained in the third embodiment, and the recommend information determining unit 115 executes the operations explained in the third embodiment, thereby determining the applications as the recommend candidates. The recommend information determining unit 115 outputs the recommend information including the application names of the recommend candidates or the like to the recommend information displaying device 160. The recommend information displaying device 160 includes the recommend information to the analysis object user by displaying the received recommend information on a display screen.

According to the embodiment, the multiple user groups and the transition models generated outside the terminal device are installed in the terminal device and used. Therefore, even if the terminal device does has no function of generating the multiple user group and the transition models, the terminal device can determine the transition destination and generate the recommend information based on the transition destination by using the transition models.

### Sixth Embodiment

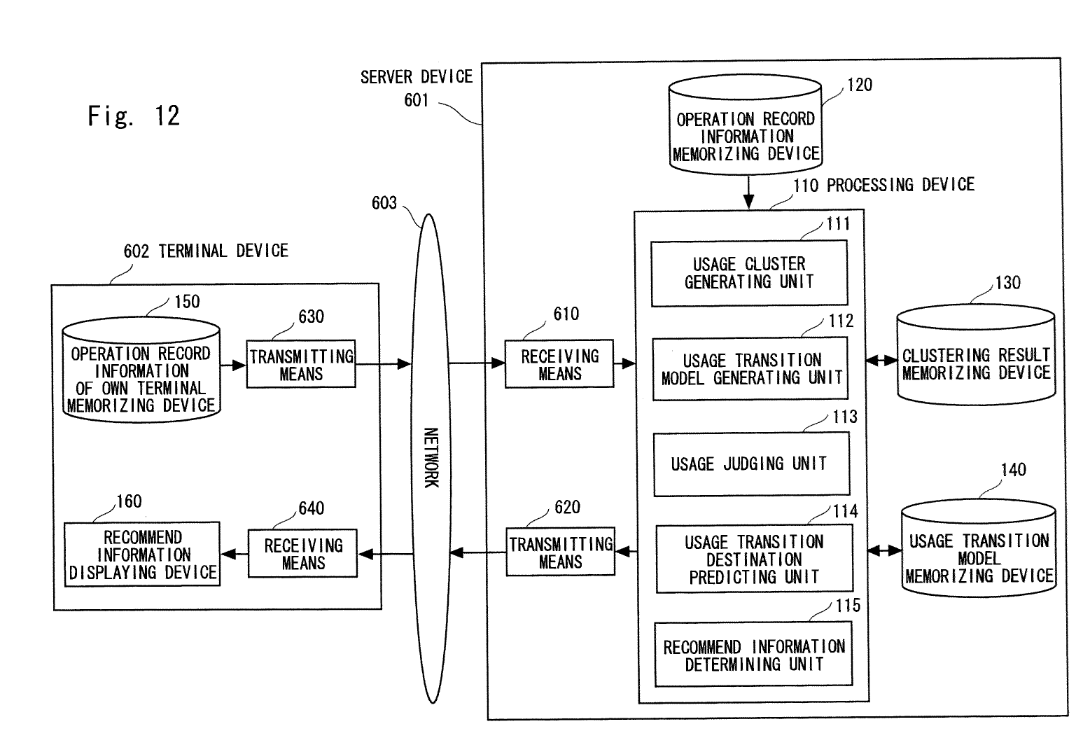

Referring to FIG. 12, a sixth embodiment of the invention is composed of a server device 601 and a terminal device 602 which can communicate with each other through a network 603. The server device 601 includes the processor device 110 including the usage cluster generating unit 111, the usage transition model generating unit 112, the usage judging unit 113, the usage transition destination predicting unit 114, and the recommend information determining unit 115, the operation record information memorizing device 120, the clustering result memorizing device 130, and the transition model memorizing device 140, which are described in the third embodiment. The terminal device 602 includes the memory device 150 for memorizing the operation record information of the own device and the displaying device 160 for displaying the recommend information. Moreover, the server device 601 includes a transmitting means 620 and a receiving means 610 which perform a data communication with the terminal device 602 through the network 603, and the terminal device 602 includes a transmitting means 630. The receiving means 640 which perform a data communication with the server device 601 through the network 603.

The usage cluster generating unit 111 and the usage transition model generating unit 112 in the server device 601 execute the operations explained in the third embodiment and generate information on the multiple user groups in the clustering result memorizing device 130.

The transmitting means 630 of the terminal device 602 reads out the operation record information from the memory device 150 at a suitable time when the analysis object user uses the terminal device 602, and transmits it to the server device 601 through the network 603. In the server device 601, this operation record information is received at the receiving means 610 and input to the usage judging unit 113 of the processing device 110.

The usage judging unit 113 of the server device 601 executes the operations explained in the third embodiment based on the received operation record information of the analysis object user and judges the user group to which the analysis object user belongs. Subsequently, the usage transition destination predicting unit 114 predicts the user group to which the user subsequently transits by the method explained in the third embodiment, and the predicting information determining unit 115 executes the operations explained in the third embodiment and determines the applications as the recommend candidates. Then, the recommend information determining unit 115 transmits the recommend information including the application names or the like of the recommend candidates to the terminal device 602 through the transmitting means 620 via the network 603.

In the terminal device 602, the recommend information transmitted from the server device 601 is received at the receiving means 640 and output to the recommend information displaying device 160. The recommend information displaying device 160 presents the recommend information to the analysis object user by displaying the received recommend information on a display screen.

Meanwhile, in this embodiment, the operation record information of the analysis object user is transmitted from the terminal device of the analysis object user to the server device 601. However, in the case where the terminal device 602 is a thin client terminal, the operation record information is not stored in the terminal device 602 but in the server side of the thin client system. Therefore, an embodiment in which the server device 601 obtains the operation record information of the analysis object server from the server side of the thin client system is possible.

According to the embodiment, a service in which the user group to which the user using the terminal device subsequently transits is predicted and a function used in this user group is recommended can be realized as a kind of Web services.

As described above, the embodiments of the invention are explained. However, the invention is not limited to the above examples and other various changes and additions can be made. Further, the function of the user model processing device of the invention can be obviously realized as hardware and also realized by a computer and a program. The program can be stored and provided in a computer readable medium such as the magnetic disk, and a semiconductor memory, or the like. The program is read by a computer at the start-up of the computer or the like, and makes the computer is caused to function as functional means including the usage cluster generating unit, and the usage transition model generating unit, the usage judging unit, the usage transition destination predicting unit, and the recommend information determining unit described in each of the embodiments by controlling operations of the computer.

Although the present invention is described above by referring to the embodiments, the present invention is not limited to the above-described embodiments. Various changes and modifications as would be obvious to one skilled in the art may be made to the structure and the details of the present invention without departing from the scope of the invention.

This application is based upon and claims the benefit of priority from Japanese patent application No. 2008-190655 filed on Jul. 24, 2008, the disclosure of which is incorporated herein in its entirety by reference.

### INDUSTRIAL APPLICABILITY

The invention can be applied to a system in which multiple users exist, for example, a cellular phone, a personal computer, a specific application running on a computer, an office system, an ATM, a terminal of KIOSK, a hard disk recorder, a television set, or the other information home electronics.

### REFERENCE SIGNS LIST

100, 200, 300 . . . USER MODEL PROCESSING DEVICE
110 . . . PROCESSING DEVICE
111 . . . USAGE CLUSTER GENERATING UNIT
112 . . . USAGE TRANSITION MODEL GENERATING UNIT
113 . . . USAGE JUDGING UNIT
114 . . . USAGE TRANSITION DESTINATION PREDICTING UNIT
115 . . . RECOMMEND INFORMATION DETERMING UNIT
120 . . . OPERATION RECORD INFORMATION MEMORIZING DEVICE
121 . . . OPERATION RECORD INFORMATION OF USER
130 . . . CLUSTERING RESULT MEMORIZING DEVICE
131 . . . USER GROUP
140 . . . TRANSITION MODEL MEMORIZING DEVICE
141 . . . USAGE TRANSITION MODEL

1. A user model processing device comprising:
a usage cluster generating unit for generating a plurality of user groups consisting of users based on operation record information about a plurality of first users of a terminal device, the users having similar characteristic values representing usage characteristics calculated from the operation record information; and
a usage transition model generating unit for analyzing that the characteristic value representing the usage characteristic calculated from the operation record information is classified in which of the plurality of user groups for each operation record information of each divided section, and for generating a transition model representing a transition relationship between the user groups based on a result of the analysis, the divided section being obtained by dividing the operation record information about a plurality of second users of the terminal device by a time.

2. The user model processing device according to claim 1, wherein the usage cluster generating unit calculates a characteristic value vector representing the usage characteristic from the operation record information about the plurality of first users, and clusters the calculated characteristic value vector, thereby generating the plurality of user group consisting of the users whose usages are similar.

3. The user model processing device according to claim 1, wherein the transition model generated by the usage transition model generating unit is a model representing a transition between the user groups by a conditional probability with respect to an elapsed time.

4. The user model processing device according to claim 1, wherein the transition model generated by the usage transition model generating unit is a model representing a transition between the user groups by a conditional probability with respect to an behavior.

5. The user model processing device according to claim 1, comprising:
a usage judging unit for judging which of the plurality of user groups a user belongs in, the user having the usage characteristic represented in the operation record information about the analysis object user of the terminal device, and
a usage transition destination predicting unit for predicting, based on the transition model, a user group to which the user group judged by the usage judging unit subsequently transits.

6. A user model processing device comprising:
a clustering result memorizing unit for memorizing a plurality of user groups consisting of users based on operation record information about a plurality of first users of a terminal device, the users having similar characteristic values representing usage characteristics calculated from the operation record information;
a transition model memorizing unit for memorizing a transition model representing a transition relationship between the user groups, the transition model being generated based on a result of analysis that the characteristic value is classified in which of the usage characteristics of the plurality of user groups for each operation record information of each divided section, the characteristic value representing the usage characteristic calculated from the operation record information, the divided section being obtained by dividing the operation record information about a plurality of second users of the terminal device;
a usage judging unit for judging which of the plurality of user groups a user is classified in, the user having the usage characteristic represented in the operation record information about the analysis object user of the terminal device; and
a usage transition destination predicting unit for predicting, based on the transition model, a user group to which the user group judged by the usage judging unit subsequently transits.

7. The user model processing device according to claim 5, wherein the usage judging unit calculates a characteristic value vector representing the usage characteristic based on the operation record information about the analysis object user of the terminal device, calculates a distance between the calculated characteristic value vector and characteristic value vectors of the plurality of user groups, and determines a user group having a shortest distance as a judgment result.

8. The user model processing device according to claim 5, wherein the usage transition destination predicting unit determines a user group whose transition probability is highest as a predicted result.

9. The user model processing device according to claim 5, wherein the usage transition destination predicting unit selects a user group satisfying a predetermined condition as a predicted result from among transition destination user groups whose transition probability is equal to or higher than a threshold.

10. The user model processing device according to claim 9, wherein the predetermined condition is a condition for mastering the terminal device better.

11. The user model processing device according to claim 10, wherein the usage transition destination predicting unit calculates an evaluate value representing a learning level based on the operation record information used to generate the user group for each of the plurality of user groups, and selects a user group having a largest evaluate value as a predicted result from among transition destination user groups whose transition a probability is equal to or higher than a threshold.

12. The user model processing device according to claim 10, wherein
the usage transition destination predicting unit calculates an evaluate value representing a user's satisfaction level based on feedback information from the user and selects a user group having a largest evaluate value as an predicted result from among transition destination user groups whose transition probability is equal to or higher than a threshold, and
the feedback information is memorized with being associated with the operation record information used to generate the user group for each of the plurality of user groups.

13. The user model processing device according to claim 5, comprising a recommend information determining unit for determining and outputting recommend information suitable for the user group of the usage transition destination represented by the predicted result of the usage transition destination predicting unit.

14. The user model processing device according to claim 13, wherein the recommend information is information for recommending a whole or a part of applications used in the user group of the usage transition destination.

15. The user model processing device according to claim 13, comprising a recommend information displaying unit that is provided in the terminal device used by the analysis object user and displays the recommend information determined by the recommend information determining unit.

16. A user model processing method comprising:
a) a usage cluster generating step of generating, by a usage cluster generating unit, a plurality of user groups consisting of users based on operation record information about a plurality of first users of a terminal device, the users having similar characteristic values representing usage characteristics calculated from the operation record information; and
b) a usage transition model generating step of analyzing, by a usage transition model generating unit, that the characteristic value representing the usage characteristic calculated from the operation record information is classified in which of the usage characteristics of the plurality of user groups for each operation record information of each divided section, and generating a transition model representing a transition relationship between the user groups based on an analysis result, the divided section being obtained by dividing the operation record information about a plurality of second users of the terminal device by a time.

17. The user model processing method according to claim 16, wherein in the usage cluster generating step a), the usage cluster generating unit calculates a characteristic value vector representing the usage characteristic from the operation record information about the plurality of first users and clusters the calculated characteristic value vector, thereby generating the plurality of user groups consisting of the users whose usages are similar.

18. The user model processing method according to claim 16, wherein the transition model generated in the usage transition model generating step b) is a model representing a transition between the user groups by a conditional probability with respect to an elapsed time.

19. The user model processing method according to claim 16, wherein the transition model generated in the usage transition model generating step b) is a model representing a transition between the user groups by a conditional probability with respect to a behavior.

20. The user model processing method according to claim 16, further comprising:
c) a usage judging step of judging, by a usage judging unit, that the user having the usage characteristic represented in the operation record information about the analysis object user of the terminal device is classified in which of the plurality of user groups; and
d) a usage transition destination predicting step of predicting, by a usage transition destination predicting unit, that the user group judged in the usage judging step a) subsequently transits to which of the user groups.

21. A user model processing method comprising:
c) a usage judging step of judging, by a usage judging unit, that a user having a usage characteristic represented in operation record information about an analysis object user of a terminal device is classified in which of a plurality of user groups by referring to a clustering result memorizing unit for memorizing the plurality of user groups consisting of users having similar characteristic values representing usage characteristics calculated from the operation record information, the plurality of user groups being generated based on the operation record information about a plurality of first users of the terminal device; and
d) a usage transition destination predicting step of predicting, by a usage transition destination predicting unit, based on the transition model, the user group judged by the usage judging step subsequently transits to which of the plurality of user groups for each operation record information of a divided section by referring to a transition model memorizing unit for memorizing a transition model generated based on a result of analyzing that a user having the usage characteristic represented in the operation record information is classified in which of the plurality of user groups, the transition model representing a transition relationship between the user groups, the divided section being obtained by dividing the operation record information of a plurality about second users of the terminal device is divided to.

22. The user model processing method according to claim 20, wherein, in the usage judging step c), the usage judging unit calculates a characteristic value vector representing the usage characteristic based on the operation record information about the analysis object user of the terminal device, calculates a distance between the calculated characteristic value vector and characteristic value vectors of the plurality of user groups, and determines a user group having a shortest distance as a judged result.

23. The user model processing method according to claim 20, wherein, in the usage transition destination predicting step d), the usage transition destination predicting unit determines a user group whose transition probability is highest as a predicted result.

24. The user model processing method according to claim 20, wherein, in the usage transition destination predicting step d), the usage transition destination predicting unit selects a user group satisfying a predetermined condition as a predicted result from among transition destination user groups whose transition probability is equal to or higher than a threshold.

25. The user model processing method according to claim 24, wherein the predetermined condition is a condition for mastering the terminal device better.

26. The user model processing method according to claim 25, wherein, in the usage transition destination predicting step d), the usage transition destination predicting unit calculates an evaluate value representing a learning level based on the operation record information used to generate the user group for each of the plurality of user groups, and selects a user group having a largest evaluate value as a predicted result among transition destination user groups whose transition probability is equal to or higher than a threshold.

27. The user model processing method according to claim 25, wherein,
in the usage transition destination predicting step d), the usage transition destination predicting unit calculates an evaluate value representing a user's satisfaction level based on feedback information from the user and selects the user group having a largest evaluate value as an predicted result from among transition destination user groups whose transition probability is equal to or higher than a threshold, and
the feedback information is memorized with being associated with the operation record information used to generate the user group for each of the plurality of user groups.

28. The user model processing method according to claim 20, further comprising e) a recommend information determining step of determining and outputting, by a recommend information determining unit, recommend information suitable for the user group of the usage transition destination represented by the predicted result of the usage transition destination predicting step d).

29. The user model processing method according to claim 28, wherein the recommend information is information for recommending a whole or a part of applications used in the user group of the usage transition destination.

30. The user model processing method according to claim 28, further comprising f) recommend information displaying step of displaying, by a recommend information displaying unit, the recommend information determined in e) the recommend information determining step, the recommend information display unit being provided in the terminal device used by the analysis object user.

31. A record medium storing a program for causing a computer to function as:
a usage cluster generating unit for generating a plurality of user groups consisting of users based on operation record information about a plurality of first users of a terminal device, the users having similar characteristic values representing usage characteristics calculated from the operation record information; and
a usage transition model generating unit for analyzing that the characteristic value representing the usage characteristic calculated from the operation record information is classified in which of usage characteristic of the plurality of user groups for each operation record information of each divided section, and generating a transition model representing a transition relationship between the user groups based on a result of the analysis, the divided section being obtained by dividing the operation record information of a plurality of second users of the terminal device by a time.

32. The record medium storing the program according to claim 31, wherein the usage cluster generating unit calculates a characteristic value vector representing the usage characteristic from the operation record information about the plurality of first users, and clusters the calculated characteristic value vector, thereby generating the plurality of user groups consisting of the users whose usages are similar.

33. The record medium storing the program according to claim 31, wherein the transition model generated by the usage transition model generating unit is a model representing a transition between the user groups by a conditional probability with respect to an elapsed time.

34. The record medium storing the program according to claim 31, wherein the transition model generated by the usage transition model generating unit is a model representing a transition between the user groups by a conditional probability with respect to a behavior.

35. The record medium storing the program according to claim 31, wherein the program causes the computer to further function as:
a usage judging unit for judging that the user having the usage characteristic represented in the operation record information about the analysis object user of the terminal device is classified in which of the plurality of user groups, and
a usage transition destination predicting unit for predicting that the user group judged by the usage judging unit subsequently transits to which of the user groups.

36. A record medium storing a program for causing a computer to function as:
a usage judging unit for judging that a user having a usage characteristic represented in operation record information about an analysis object user of a terminal device is classified in which of a plurality of user groups; and
a usage transition destination predicting unit for predicting that a user group judged by the usage judging unit subsequently transits to which of the user groups based on a transition model,
wherein the computer includes a clustering result memorizing unit for memorizing a plurality of user groups consisting of users generated based on operation record information about a plurality of first users, the users having similar characteristic values representing usage characteristics calculated from the operation record information; and
a transition model memorizing unit for memorizing the transition model representing a transition relationship between the user groups, the transition model being generated based on a result of analyzing that the characteristic value representing the usage characteristic calculated from the operation record information is classified in which of the characteristic values of the plurality of user groups for each operation record information of each divided section, the divided section being obtained by dividing the operation record information about a plurality of second users of the terminal device by a time.

37. The record medium storing the program according to claim 35, wherein the usage judging unit calculates a characteristic value vector representing the usage characteristic based on the operation record information about the analysis object user of the terminal device, calculates a distance between the calculated characteristic value vector and characteristic value vectors of the plurality of user groups, and determines a user group having a shortest distance as a judged result.

38. The record medium storing the program according to claim 35, wherein the usage transition destination predicting unit determines a user group whose transition probability is highest as a predicted result.

39. The record medium storing the program according to claim 35, wherein the usage transition destination predicting unit selects a user group satisfying a predetermined condition as a predicted result from among transition destination user groups whose transition probability is equal to or higher than a threshold.

40. The record medium storing the program according to claim 39, wherein the predetermined condition is a condition for mastering the terminal device better.

41. The record medium storing the program according to claim 40, wherein the usage transition destination predicting unit calculates an evaluate value representing a learning level based on the operation record information used to generate the user group for each of the plurality of user groups, and selects a user group having largest evaluate value as a predicted result from among transition destination user groups whose transition probability is equal to or higher than a threshold.

42. The record medium storing the program according to claim 40, wherein
the usage transition destination predicting unit calculates an evaluate value representing a user's satisfaction level based on feedback information from the user and selects the user group having a largest evaluate value as an estimated result from among transition destination user groups whose transition probability is equal to or higher than a threshold, and
the feedback information is memorized with being associated with the operation record information used to generate the user group for each of the plurality of user groups.

43. The record medium storing the program according to claim 35, wherein the program causes the computer to further function as a recommend information determining unit for determining and outputting recommend information suitable for the user group of the usage transition destination represented by the predicted result of the usage transition destination predicting unit.

44. The record medium storing the program according to claim 43, wherein the recommend information is information for recommending a whole or a part of applications used in the user group of the usage transition destination.

45. The record medium storing the program according to claim 43, wherein the program causes the computer to further function as a recommend information displaying unit for displaying the recommend information determined by the recommend information determining unit, the recommend information displaying unit being provided in the terminal device used by the analysis object user.
